(19) United States
(12) Patent Application Publication
(10) Pub. No.: US 2026/0244739 A1
(43) Pub. Date: Aug. 20, 2026

(54) SYSTEMS AND METHODS FOR TERMINATING UNAUTHORIZED CODE DEPLOYMENTS

(71) Applicant: Capital One Services, LLC, McLean, VA (US)

(72) Inventors: Kamlesh VAGHELA, Schaumburg, IL (US); Mihir VORA, Glen Allen, VA (US); Bhavik Shantilal GUDKA, Schaumburg, IL (US); Bal Reddy CHERLAPALLY, Glen Allen, VA (US)

(73) Assignee: Capital One Services, LLC, McLean, VA (US)

(21) Appl. No.: 19/057,946

(22) Filed: Feb. 19, 2025

(51) Int. Cl. G06F 21/55; G06F 9/54

(52) U.S. Cl. CPC G06F 21/554; G06F 9/547; G06F 2221/033

(57) ABSTRACT

In some implementations, a device may detect an attempt by a code deployment pipeline to use a deployment agent to deploy code to a computing environment. The code may be from a code repository that relates to a software application. The device may retrieve a list of change requests associated with the software application. The device may determine whether a change request, from the list of change requests, validates the attempt. The device may selectively terminate or cause deployment of the code to the computing environment by the deployment agent based on whether the change request validates the attempt.

### BACKGROUND

A software pipeline is a set of automated processes that enable the continuous integration, integration, delivery, and deployment of software. Pipeline tools provide automation and management of the various stages of a software pipeline, including building, testing, and deploying code, and therefore facilitate implementation of continuous integration and continuous delivery (CI/CD) practices. For example, a pipeline tool may automate repetitive tasks, such as code compilation, testing, and deployment, may integrate with various development tools and services, such as version control systems, testing frameworks, and cloud platforms, and may provide real-time monitoring and reporting of pipeline activities, among other examples. Pipeline tools may utilize “agents” to execute specific tasks, such as building, testing, and deploying software. These agents are assigned labels to categorize them by environment and are configured with appropriate permissions using identity and access management (IAM) roles, security groups, and proxies. Current pipeline tools face several security challenges, including the risk of unauthorized use of agents. If production agents are not properly utilized, unauthorized users could deploy unapproved code changes to a production environment, potentially leading to system instability or data breaches.

### SUMMARY

Methods and systems are described herein for novel uses and/or improvements to code deployment in CI/CD systems. As one example, methods and systems are described herein for deploying authorized code changes to a computing environment, such as a production environment, while blocking the deployment of unauthorized code changes.

As described above, a pipeline of a CI/CD system may utilize an agent to deploy code changes to a computing environment. Existing systems lack sufficient safeguards regarding the use of agents by pipelines. For example, a pipeline may be defined by information for the CI/CD system generated and transmitted by a user device and indicating the utilization of a production agent for deploying code changes to a production environment. However, existing systems lack validation mechanisms to ensure that the user is authorized to use the agent and/or to ensure that the code changes have been approved by an appropriate authority. As a result, code changes that have not been properly validated or approved may be deployed to a computing environment (e.g., a production environment) resulting in instability, security vulnerabilities, and/or misuse in the computing environment. This can lead to unplanned system downtime, functionality losses, security breaches, or the like.

To overcome these technical deficiencies, methods and systems disclosed herein enable the validation of attempts to use a deployment agent (e.g., a production agent) prior to deployment of code changes to a computing environment (e.g., a production environment). For example, upon detecting an attempt by a pipeline to use a particular deployment agent, the system may intercept the attempt, thereby pausing the deployment until the attempt can be validated. In this way, the system restricts the deployment of code changes, thereby ensuring that only authorized changes are deployed to the computing environment. In some embodiments, the system may validate the attempt using change requests for a software application associated with a code repository that contains the code. A change request may indicate whether code changes have been authorized and/or may indicate an authorized deployment time window for deploying the code changes. For example, the system may determine whether a change request for the software application validates the attempt by checking whether the change request has an approved status and whether a deployment time window indicated by the change request encompasses a time of the attempt. Passing both of these checks indicates that there is an approved and timely code deployment for the software application corresponding to the attempt, thereby indicating that the attempt is proper. However, if there are no change requests that validate the attempt, then the system may terminate the deployment of the code to the computing environment (e.g., by causing aborting of the pipeline). Terminating invalid (e.g., unauthorized and/or untimely) code deployments reduces instability, security vulnerabilities, premature introduction of features, inadvertent rolling back of features, or the like, that may otherwise occur. Thus, methods and systems disclosed herein improve the stability, functionality, and security of a computing environment. Moreover, methods and systems disclosed herein conserve substantial processing resources that may otherwise be expended toward remediating an invalid deployment (e.g., processing resources used for rolling back to an earlier, stable codebase).

In some aspects, a system for terminating unauthorized code deployments may detect, using an event listener, an attempt by a code deployment pipeline to use a deployment agent to deploy code to a computing environment, where the code is from a code repository that relates to a software application. The system may intercept the attempt prior to deployment of the code to the computing environment by the deployment agent, where interception of the attempt pauses deployment of the code to the computing environment. The system may identify, based on metadata associated with the attempt, the code repository that contains the code. The system may transmit, using a first application programming interface (API) endpoint for a code repository registry service, a first API request requesting information that identifies the software application associated with the code repository. The system may receive, at the first API endpoint, a first API response containing the information that identifies the software application. The system may transmit, using a second API endpoint for a change management system, a second API request requesting a list of change requests associated with the software application. The system may receive, at the second API endpoint, the list of change requests associated with the software application. The system may determine whether a change request, from the list of change requests, validates the attempt, where the change request validates the attempt if the change request is associated with an approved status and indicates a deployment time window that encompasses a time of the attempt. The system may terminate the deployment of the code to the computing environment by the deployment agent based on a determination that no change request validates the attempt.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an example environment for terminating unauthorized code deployments, in accordance with one or more embodiments.

FIG. 2 shows an illustrative diagram for terminating unauthorized code deployments, in accordance with one or more embodiments.

FIG. 3 shows an example computer system, in accordance with one or more embodiments.

FIG. 4 shows a flowchart of the steps involved in terminating unauthorized code deployments, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

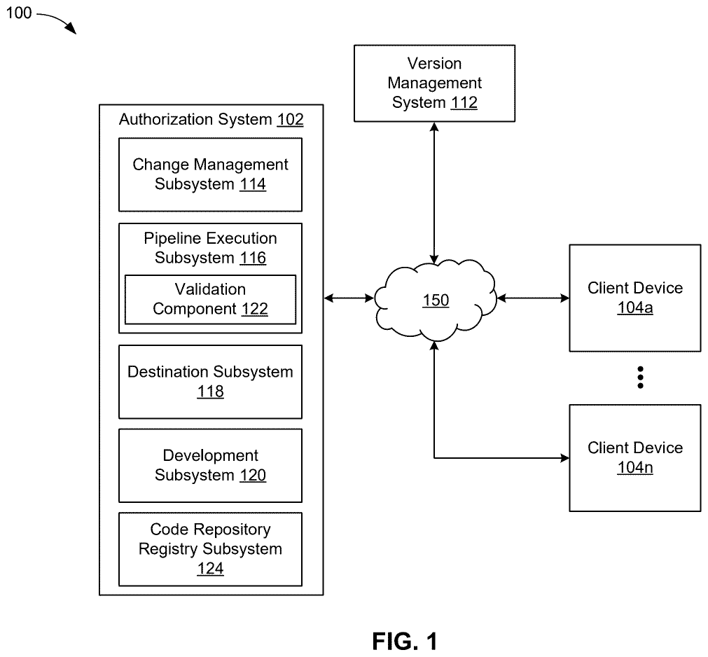

FIG. 1 shows an example environment 100 for terminating unauthorized code deployments, in accordance with one or more embodiments. As shown in FIG. 1, environment 100 may include authorization system 102, client device 104 (client devices 104a-104n), version management system 112, or other components. Authorization system 102 may include software, hardware, or a combination thereof. For example, authorization system 102 may be hosted on a physical server or a virtual server that is running on a physical computer. In some embodiments, authorization system 102 may be configured on a user device (e.g., a laptop computer, a smartphone, a desktop computer, an electronic tablet, or another suitable user device).

Authorization system 102 may include a change management subsystem 114, a pipeline execution subsystem 116, a destination subsystem 118, a development subsystem 120, a code repository registry subsystem 124, or other components. The subsystems of the authorization system 102 may be implemented as software, hardware, or a combination thereof. The subsystems of the authorization system 102 may be hosted on the same physical server and/or virtual server or on different physical servers and/or virtual servers. In some embodiments, authorization system 102 may include the version management system 112. The “subsystems” of the authorization system 102 may sometimes be referred to as “systems.”

By way of example, authorization system 102 may include a distributed system, a cloud-based system, a container environment on one or more servers, or other systems. Each client device 104 may include any type of mobile terminal, fixed terminal, or other device. By the way of example, client device 104 may include any computing device, such as a personal computer (PC), a laptop computer, a tablet computer, a hand-held computer, other computer equipment. Users may, for instance, utilize one or more client devices 104 to interact with one another, one or more servers, or other components of environment 100.

Devices of environment 100 may communicate with each other via a communication network 150 (e.g., Internet, a mobile phone network, a mobile voice or data network, a cable network, a public switched telephone network, or other types of communications networks or combinations of communications networks). The communication network may be a wireless or wired network. Subsystems of the authorization system 102 may communicate with each other via messages (e.g., according to a messaging protocol) or via an application programming interface (API). The API (e.g., a REST or Web services API) may provide a decoupled interface to application data and functionality. The API may use various architectural arrangements, including microservice and open API approaches. Accordingly, communication between subsystems of the authorization system 102 may be in the form of API requests and API responses.

It should be noted that, while one or more operations are described herein as being performed by particular devices of environment 100, those operations may, in some embodiments, be performed by other devices of environment 100. As an example, while one or more operations are described herein as being performed by components of authorization system 102, those operations may, in some embodiments, be performed by components of client device 104.

Version management system 112 may manage code repositories (e.g., implemented in a database, a data warehouse, a cloud storage system, a file storage system, a data lake, or the like). A code repository may serve as a storage location for code files (e.g., for a particular application) and their revision histories. The version management system 112 may also provide version management in the code repositories, thereby enabling developers to track changes, revert to previous versions, and merge contributions from multiple collaborators. This may be achieved through the use of branches, pull requests, and commit histories. A branch is a separate line of development created from a main codebase, allowing developers to work on features or fixes independently. Changes are saved as commits, which are snapshots of the code at specific points in time. After completion of the work on a branch, a pull request can be created requesting to merge changes back into the main branch. Upon approval of the pull request (e.g., by a supervisor or other development team members), the changes may be integrated into the main codebase.

Change management subsystem 114 may provide incident, problem, change, and request management. The change management subsystem 114 may arrange this data on a per-software application basis. “Software application” may refer to an entire software application or a component of a software application. The change management subsystem 114 may manage change requests for software applications. “Change request” may refer to a request seeking authorization for a change made to code for a software application. Thus, the change management subsystem 114 may facilitate tracking and management of change requests, and furthermore may provides mechanisms for change request approval (e.g., by authorized users) before implementation of code changes. The code repository registry subsystem 124 may maintain a list of associations between software applications and code repositories. For example, the code repository registry subsystem 124 may indicate that a code repository A maps to a software application B, or that a code repository C maps to a component D of a software application.

Pipeline execution subsystem 116 may include a CI/CD tool. For example, pipeline execution subsystem 116 may implement a software pipeline via a pipeline tool. In some embodiments, the pipeline execution subsystem 116 (e.g., using the pipeline tool) may perform different types of actions on application code for progressing an application through the pipeline (e.g., to deploy the application in destination subsystem 118, such as a production environment). The actions may include software code quality actions, compliance actions, or other actions. As an example, software code quality actions may include linting, building, testing, validating, deploying, or other actions on the application code. The pipeline execution subsystem 116 may deploy the application code in destination subsystem 118 if all the actions are performed successfully.

In some embodiments, linting is a process that analyzes source code to flag programming errors, bugs, stylistic errors, or suspicious constructs. In some embodiments, building is a process of generating binaries of the application code to create deliverables that will be passed to the subsequent stages, such as testing. In some embodiments, testing is a process in which an application is rigorously tested to ensure that it meets all desired system qualities (e.g., functionality, security, performance, or other qualities). In some embodiments, deployment is a process in which an application is installed in a testing environment, a quality assurance (QA) environment, a staging environment, a production environment, or the like.

In some embodiments, CI refers to the practice of automating application lint, build and testing actions in the software pipeline. After users (e.g., software developers) create or update the application code, they commit their changes to a source control repository (e.g., version management system 112). This commit may launch an automated lint, build or testing operation that validates the application code whenever changes are checked into the repository. In some embodiments, CD refers to automation of application delivery process by adding a deploy stage or action, which is where an application is prepared and released for production (e.g., in destination subsystem 118). The deploy stage may include test and code-release automation that ensures the application code is ready for deployment. As part of this process, the application code may be compiled and delivered to a staging area in preparation for production. After the pipeline execution subsystem 116 determines that software routines have completed executing successfully, an application may be deployed to destination subsystem 118 (e.g., production environment). For example, the pipeline execution subsystem 116 may send a message to the destination subsystem 118 indicating the availability of the application for deployment, which may cause the destination subsystem 118 to deploy the application. After the application is deployed in the destination subsystem 118, the application may be available to one or more consumers (e.g., users, automated processes, or the like) of the application.

The pipeline execution subsystem 116 includes various software or hardware components for executing various actions on the application code to progress an application in the pipeline. In some embodiments, pipeline execution subsystem 116 includes or interacts with the version management system 112, which provides version management and other management of application code. The version management system 112 stores the application code in a repository. When users commit the application code in the version management system 112 (e.g., in a version management system), execution of the pipeline may be triggered via the pipeline execution subsystem 116.

In some embodiments, the pipeline execution subsystem 116 also includes various software components and hardware components (e.g., a server or other hardware components) for setting up a production environment to deploy the application. For example, if the production environment in which an application is to be deployed is a cloud platform, pipeline execution subsystem 116 may perform the tasks for packaging the application code in a format required by cloud platform, setting up a cloud platform cluster, and deploying the application. Similarly, pipeline execution subsystem 116 also includes various software components and hardware components for setting up a staging environment to deploy the application. In some embodiments, the staging environment is a subset of a production environment and includes an environment setup that resembles the production environment as closely as possible and may connect to other production services and data, such as databases. In some embodiments, a staging environment may be used to test all the installation/configuration/migration scripts and procedures before they are applied to a production environment.

The pipeline execution subsystem 116 may implement a plurality of agents (e.g., a first agent, a second agent, a third agent, etc.). An agent (sometimes referred to as a “worker”) may include a software and/or hardware instance configured for executing one or more tasks, such as building, testing, and/or deploying an application. An agent may be launched on a physical machine, a virtual machine, a compute cluster, or the like. In some embodiments, each agent may be configured with permissions (e.g., IAM roles, security groups, and/or proxies) to deploy an application to a respective environment. For example, each agent may be associated with a respective dedicated label that indicates a categorization of the agent to an environment. In some embodiments, the pipeline execution subsystem 116 may include a production agent configured with permissions to deploy an application only to a production environment, a development agent configured with permissions to deploy an application only to a development environment, a QA agent configured with permissions to deploy an application only to a QA environment, and so forth.

In some embodiments, the pipeline execution subsystem 116 may include a validation component 122. The validation component 122 may be configured to intercept attempts by a code deployment pipeline to deploy code to a computing environment, to validate the attempt as described herein, and to allow or terminate the deployment based on the validation. In some embodiments, the validation component 122 may be a plugin for a pipeline tool of the pipeline execution subsystem 116. “Computing environment” may refer to a configuration of hardware, software, and/or network resources designed to support the execution and management of applications and/or services. A computing environment may include a testing environment, a QA environment, a staging environment, a production environment, or the like.

The development subsystem 120 facilitates development of an application. The development subsystem 120 may include various software components and hardware components (e.g., a server or other hardware components) for developing an application. The development subsystem 120 may include software components such as an integrated development environment (IDE), application packages, libraries, compilers, virtual machines, or other software components, to write or generate the application code. The development subsystem 120 may support development of an application in one or more programming languages (e.g., Python, Java, C++, or other programming languages). A user (e.g., software developer or other user) may interact with development subsystem 120 using client device 104a.

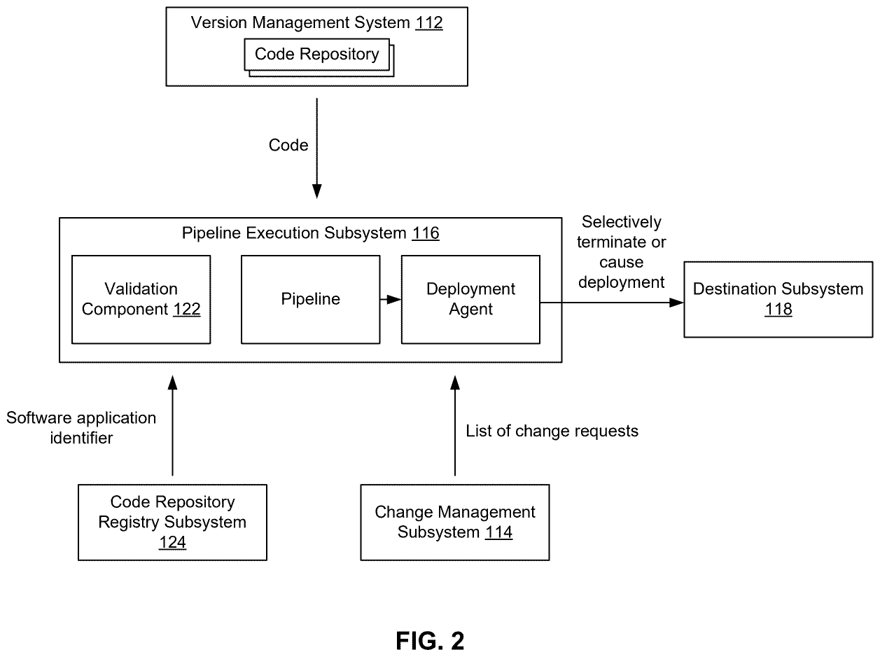

FIG. 2 shows an illustrative diagram for terminating unauthorized code deployments, in accordance with one or more embodiments. Prior to the operations shown in FIG. 2, there may have been a change to code (e.g., a codebase) in a code repository of the version management system 112. The code may be associated with a software application (e.g., an entire software application or a component of a software application). For example, one or more users (e.g., developers) may make changes to the code and push the changes to the code repository. Thereafter, a pull request may be generated in the version management system 112, and the pull request may be a request to merge the changes into a main branch.

The pipeline execution subsystem 116 may implement a code deployment pipeline that monitors the code repository and may detect the changes to the code. Responsive to detecting the changes to the code, the pipeline execution subsystem 116 may retrieve the latest code from the code repository, and initiate a build process for the code using the pipeline. Initiating the build process may include generating metadata for the build process. The metadata may indicate the code repository that contains the code, an entity responsible for initiating the build process (e.g., the version management system 112, a user device, or the like). Furthermore, the pipeline (e.g., a custom pipeline configured in accordance with information generated and transmitted by a user device) may request the use of a deployment agent to deploy the code to a computing environment (e.g., the destination subsystem 118). In some embodiments, the computing environment is a production environment, and therefore, the pipeline may request the use of a production agent to deploy the code.

The pipeline execution subsystem 116 (e.g., using the validation component 122) may detect the attempt by the pipeline to use a deployment agent to deploy the code. For example, the pipeline execution subsystem 116 (e.g., using the validation component 122) may detect the attempt using an event listener. For example, when an event indicating the use of a deployment agent occurs, the event listener may invoke the validation component 122, and the validation component 122 may validate the attempt to determine whether the attempt is proper or improper.

Based on detecting the attempt, the pipeline execution subsystem 116 (e.g., using the validation component 122) may intercept the attempt prior to deployment of the code to the computing environment by the deployment agent. Intercepting the attempt may pause the deployment of the code by the deployment agent to the computing environment, thereby providing time for the attempt to be validated. In some embodiments, the validation component 122 may execute synchronously with a job of the pipeline, thereby delaying the job until execution of operations of the validation component 122 are complete.

In a first validation operation, the pipeline execution subsystem 116 (e.g., using the validation component 122) may determine whether the pipeline is attempting to use a deployment agent associated with restricted use. For example, use of a production agent may be restricted due to the sensitive nature of a production environment. In some embodiments, the pipeline execution subsystem 116 (e.g., using the validation component 122) may read a label associated with the deployment agent (e.g., a name of the deployment agent), and based on the label, may determine whether the deployment agent is an agent associated with restricted use. If the deployment agent is not associated with restricted use, then the pipeline execution subsystem 116 (e.g., using the validation component 122) may terminate additional validations and allow the pipeline to use the deployment agent to deploy the code. Otherwise, if the deployment agent is associated with restricted use, then the pipeline execution subsystem 116 may perform further validation operations, as described herein.

In a second validation operation, the pipeline execution subsystem 116 (e.g., using the validation component 122) may identify the entity that initiated the attempt. For example, the pipeline execution subsystem 116 (e.g., using the validation component 122) may identify, based on metadata associated with the attempt (e.g., the metadata generated with the build process), the entity that initiated the attempt, and may determine whether the use of the deployment agent by the entity is restricted. For example, use of the deployment agent may not be restricted for entities that implement change management controls. If use of the deployment agent by the entity is not restricted (e.g., the build/deployment process was submitted by an authorized user), then the pipeline execution subsystem 116 (e.g., using the validation component 122) may terminate additional validations and allow the pipeline to use the deployment agent to deploy the code. Similarly, if the entity has previously indicated or transmitted an approval for the code deployment to the pipeline execution subsystem 116 (e.g., the build/deployment process was approved by an authorized user), then the pipeline execution subsystem 116 (e.g., using the validation component 122) may terminate additional validations and allow the pipeline to use the deployment agent to deploy the code. Otherwise, if use of the deployment agent by the entity is restricted, then the pipeline execution subsystem 116 may perform further validation operations, as described herein.

In a third validation operation, the pipeline execution subsystem 116 (e.g., using the validation component 122) may identify the code repository that contains the code. For example, the pipeline execution subsystem 116 (e.g., using the validation component 122) may identify, based on metadata associated with the attempt (e.g., the metadata generated with the build process), the code repository. In some embodiments, the pipeline execution subsystem 116 (e.g., using the validation component 122) may verify whether the code repository is associated with a version management system from which scripts are supported by the pipeline execution subsystem 116 (e.g., version management system 112). The pipeline execution subsystem 116 may terminate the deployment of the code (e.g., abort the pipeline) if such a verification fails and/or if the pipeline execution subsystem 116 cannot identify a code repository associated with the pipeline. The pipeline execution subsystem 116 may also output an error message indicating the termination of the deployment of the code and/or a reason for the termination.

The pipeline execution subsystem 116 (e.g., using the validation component 122) may then transmit a request for information that identifies the software application associated with the code repository. For example, the pipeline execution subsystem 116 may transmit a first API request using a first API endpoint for the code repository registry subsystem 124. As an example, the code repository registry subsystem 124 may reside at a resource accessible via the first API. The first API request may include information that indicates the code repository (e.g., a repository identifier, a repository uniform resource identifier, or the like). Subsequently, the pipeline execution subsystem 116 (e.g., using the validation component 122) may receive a response containing the information that identifies the software application (e.g., a software application component). For example, the pipeline execution subsystem 116 may receive, at the first API endpoint, a first API response containing the information that identifies the software application. In some embodiments, the response may indicate that there is no software application associated with the code repository. Here, the pipeline execution subsystem 116 may terminate the deployment of the code (e.g., abort the pipeline). The pipeline execution subsystem 116 may also output an error message indicating the termination of the deployment of the code and/or a reason for the termination.

Next, the pipeline execution subsystem 116 (e.g., using the validation component 122) may transmit a request for a list of change requests associated with the software application (e.g., open change requests relating to code changes awaiting deployment and that have not expired). For example, the pipeline execution subsystem 116 may transmit a second API request using a second API endpoint for the change management subsystem 114. As an example, the change management subsystem 114 may reside at a resource accessible via the second API. The second API request may include information that indicates the software application (e.g., a software application identifier). Subsequently, the pipeline execution subsystem 116 (e.g., using the validation component 122) may receive a response containing the list of change requests. For example, the pipeline execution subsystem 116 may receive, at the second API endpoint, a second API response containing the list of change requests. The list of change requests may include a single change request or multiple change requests.

In a fourth validation operation, the pipeline execution subsystem 116 (e.g., using the validation component 122) may determine whether any change request, from the list of change requests, validates the attempt. For example, a change request may validate the attempt if the change request is associated with an approved status and indicates a deployment time window (e.g., the change request may indicate a time window during which a deployment of the changed code would be valid) that encompasses a time of the attempt. An approved status may indicate that the change to the code has undergone the necessary reviews and is ready to be implemented in the computing environment (e.g., the production environment). The deployment time window encompassing the time of the attempt validates whether the attempt is too early or too late relative to the time window designated by the change request for deploying the code. Accordingly, the pipeline execution subsystem 116 (e.g., using the validation component 122) may then determine whether the change request validates the attempt based on identifying whether the change request is associated with the approved status and identifying whether the change request indicates the deployment time window that encompasses the time of the attempt. For example, the change request having the approved status and being timely indicates that there is an approved and timely code deployment for the software application corresponding to the attempt, thereby indicating that the attempt is proper. Conversely, if no timely change request is associated with an approved status, then this indicates that there is no corresponding approved and timely code deployment corresponding to the attempt, thereby indicating that the attempt is not proper.

The pipeline execution subsystem 116 (e.g., using the validation component 122) may selectively terminate or cause the deployment of the code to the computing environment by the deployment agent based on whether the change request validates the attempt. Based on a determination that there is no change request validating the attempt (e.g., the attempt has failed validation), the pipeline execution subsystem 116 (e.g., using the validation component 122) may terminate the deployment of the code to the computing environment by the deployment agent (e.g., if the attempt also was not initiated by an authorized entity or user). For example, the pipeline execution subsystem 116 may cause aborting of the pipeline. In some embodiments, the validation component 122 may pass a message to the pipeline execution subsystem 116 (e.g., using a system call or API) indicating that the deployment of the code is to be terminated. The pipeline execution subsystem 116 may also output an error message indicating the termination of the deployment of the code and/or a reason for the termination. Alternatively, based on a determination that there is a change request validating the attempt (or if the attempt was initiated by an authorized entity or user) the pipeline execution subsystem 116 (e.g., using the validation component 122) may allow (e.g., refrain from terminating, authorize, or cause) the deployment of the code to the computing environment by the deployment agent.

In some embodiments, based on a determination that there is no change request validating the attempt, but prior to terminating the deployment of the code, the pipeline execution subsystem 116 (e.g., using the validation component 122) may transmit a notification to a user device. The user device may have the authority to approve change requests. In some embodiments, the notification may indicate that the change request did not validate the attempt due to lacking approval status, and may request approval of the change request. Accordingly, in response to the notification, the pipeline execution subsystem 116 may receive (e.g., from the user device) an indication of approval for the change request. In some embodiments, the notification may indicate that the change request did not validate the attempt due to the time of the attempt falling outside of the deployment time window, and may request an extension of the deployment time window. Accordingly, in response to the notification, the pipeline execution subsystem 116 may receive (e.g., from the user device) an indication of an extension of the deployment time window (e.g., that now encompasses the time of the attempt). Based on receiving the indication of the approval or the extension, the pipeline execution subsystem 116 may refrain from terminating the deployment of the code and instead allow the pipeline to use the deployment agent to deploy the code to the computing environment. In some embodiments, upon transmitting the notification, the pipeline execution subsystem 116 (e.g., using the validation component 122) may initiate a timer, and if the indication of the approval or the extension is not received prior to expiration of the timer, then the pipeline execution subsystem 116 may proceed with terminating the deployment of the code.

In some embodiments, the pipeline execution subsystem 116 (e.g., using the validation component 122) may generate a log entry for the attempt. The log entry may indicate a time of the attempt, the code repository, the entity initiating the attempt, the software application, and/or other details relating to the attempt. The log entry may facilitate subsequent forensic analysis or analytics.

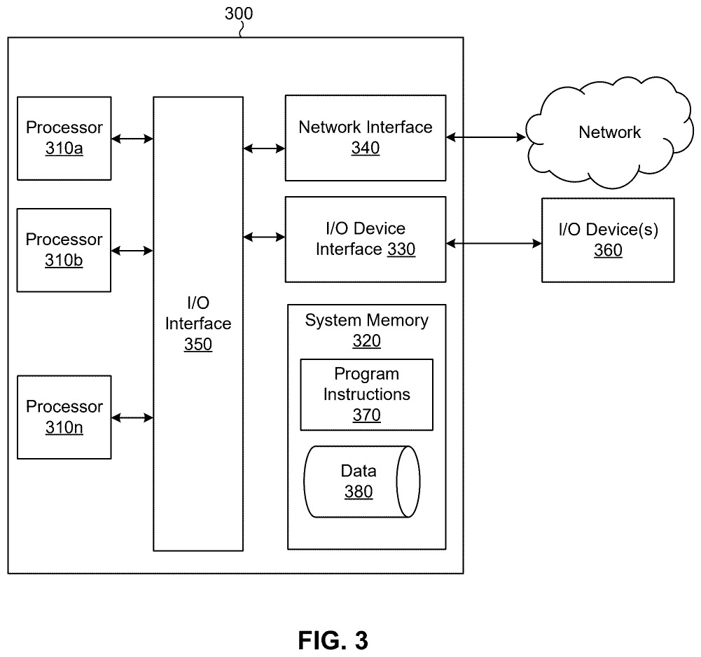

FIG. 3 shows an example computer system 300, in accordance with one or more embodiments. The authorization system 102 or subsystems thereof, a client device 104, and/or the version management system 112 may correspond to, or may include, the authorization system 102. Thus, the components of FIG. 3 may be used to perform some or all operations discussed in relation to FIGS. 1-2. Furthermore, various portions of the systems and methods described herein may include or be executed on one or more computer systems similar to computer system 300. Further, processes and modules described herein may be executed by one or more processing systems similar to that of computer system 300.

Computer system 300 may include one or more processors (e.g., processors 310a-310n) coupled to system memory 320, an input/output (I/O) device interface 330, and a network interface 340 via an I/O interface 350. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computer system 300. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 320). Computer system 300 may be a uni-processor system including one processor (e.g., processor 310a), or a multi-processor system including any number of suitable processors (e.g., 310a-310n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computer system 300 may include a plurality of computing devices (e.g., distributed computer systems) to implement various processing functions.

I/O device interface 330 may provide an interface for connection of one or more I/O devices 360 to computer system 300. I/O devices may include devices that receive input (e.g., from a user) or output information (e.g., to a user). I/O devices 360 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 360 may be connected to computer system 300 through a wired or wireless connection. I/O devices 360 may be connected to computer system 300 from a remote location. I/O devices 360 located on remote computer systems, for example, may be connected to computer system 300 via a network and network interface 340.

Network interface 340 may include a network adapter that provides for connection of computer system 300 to a network. Network interface 340 may facilitate data exchange between computer system 300 and other devices connected to the network. Network interface 340 may support wired or wireless communication. The network may include an electronic communication network, such as the Internet, a local area network (LAN), a wide area network (WAN), a cellular communications network, or the like.

System memory 320 may be configured to store program instructions 370 or data 380. Program instructions 370 may be executable by a processor (e.g., one or more of processors 310a-310n) to implement one or more embodiments of the present techniques. Program instructions 370 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 320 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM), volatile memory (e.g., random access memory (RAM), static random-access memory (SRAM), synchronous dynamic RAM (SDRAM)), bulk storage memory (e.g., CD-ROM and/or DVD-ROM, hard drives), or the like. System memory 320 may include a non-transitory computer-readable storage medium that may have program instructions stored thereon that are executable by a computer processor (e.g., one or more of processors 310a-310n) to cause the subject matter and the functional operations described herein. A memory (e.g., system memory 320) may include a single memory device and/or a plurality of memory devices (e.g., distributed memory devices).

I/O interface 350 may be configured to coordinate I/O traffic between processors 310a-310n, system memory 320, network interface 340, I/O devices 360, and/or other peripheral devices. I/O interface 350 may perform protocol, timing, or other data transformations to convert data signals from one component (e.g., system memory 320) into a format suitable for use by another component (e.g., processors 310a-310n). I/O interface 350 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 300, or multiple computer systems 300 configured to host different portions or instances of embodiments. Multiple computer systems 300 may provide for parallel or sequential processing/execution of one or more portions of the techniques described herein.

The computer system 300 described herein is merely illustrative and is not intended to limit the scope of the techniques described herein. Computer system 300 may include any combination of devices or software that may perform or otherwise provide for the performance of the techniques described herein. For example, computer system 300 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 300 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

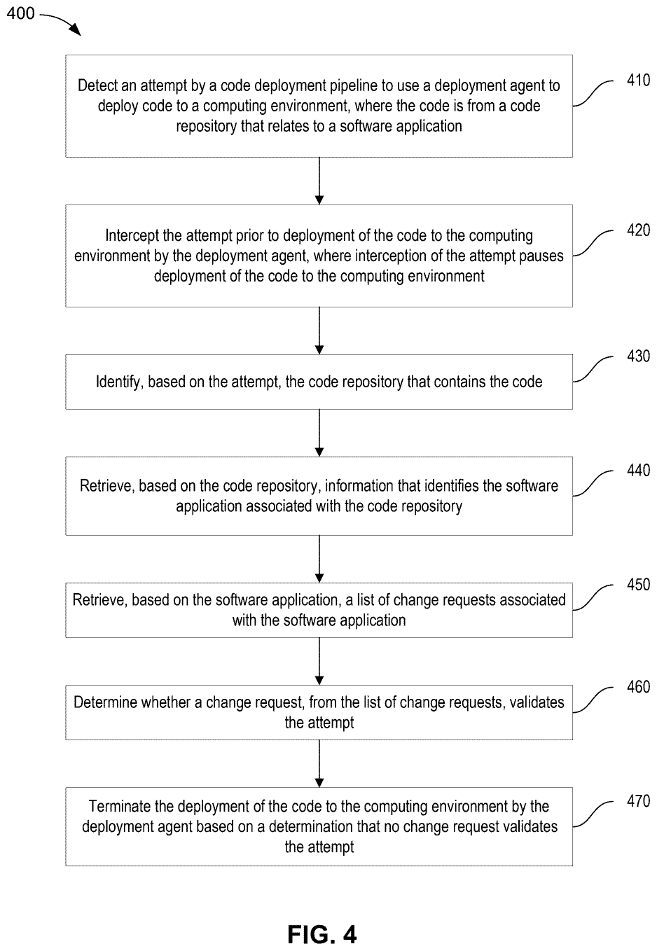

FIG. 4 shows a flowchart of the steps involved in terminating unauthorized code deployments, in accordance with one or more embodiments. For example, the system may use process 400 (e.g., as implemented on one or more system components described above) in order to deploy authorized code changes to a computing environment, such as a production environment, while blocking the deployment of unauthorized code changes.

At step 410, process 400 (e.g., using one or more components described above) may include detecting an attempt by a code deployment pipeline to use a deployment agent. For example, the system may detect an attempt by a code deployment pipeline to use a deployment agent to deploy code to a computing environment. As an example, the pipeline may be attempting to deploy code to a production environment using a deployment agent. The code may be from a code repository that relates to a software application. By detecting the use of the deployment agent, the system may identify when code is being deployed to a computing environment that may have restrictions associated with code deployments, thereby enabling enforcement of such restrictions to improve the stability and security of the computing environment.

In some embodiments, detecting the attempt may include identifying a label assigned to the deployment agent that is to be used, and identifying that the label indicates that use of the deployment agent is restricted. For example, the label may indicate the use of a deployment agent for a production environment or another restricted environment. Use of labels associated with deployment agents facilitates fast and efficient identification of deployments having restrictions, without causing undue delay to deployments that are unrestricted. In some embodiments, detecting the attempt may include detecting, using an event listener on an event stream, an event indicating the attempt. Use of an event listener enables downstream operations to be performed as attempts occur, and eliminates the need for continuous monitoring, thereby conserving processing resources.

In some embodiments, based on the attempt by the code deployment pipeline to use the deployment agent, process 400 may include retrieving the code from the code repository, and initiating a build process on the code. The initiation of the build process may generate metadata relating to the build, which may indicate the code repository that contains the code, an entity that initiated the attempt, or the like.

At step 420, process 400 (e.g., using one or more components described above) may include intercepting the attempt. For example, the system may intercept the attempt prior to deployment of the code to the computing environment by the deployment agent. As an example, the system may pause deployment of the code to the computing environment (e.g., pause the build process). By doing so, the code deployment can be validated to identify whether the code deployment is authorized, thereby facilitating the termination of unauthorized code prior to deployment and avoiding instability or vulnerability that the code may potentially introduce to the computing environment.

In some embodiments, the attempt may be intercepted based on identifying that the label, associated with the deployment agent, indicates that use of the deployment agent is restricted. In some embodiments, intercepting the attempt may include triggering, using the event listener, an execution of one or more operations synchronously with a job of the deployment agent, and executing the one or more operations to delay the job of the deployment agent until completion of the one or more operations. For example, the operations may relate to the validation of the code deployment to identify whether the code deployment is authorized. The synchronous execution of the operations with the job ensures that the job is not executed prior to the validation of the code deployment being completed, thereby reducing the use of processing resources to rollback or otherwise negate unauthorized code deployment.

At step 430, process 400 (e.g., using one or more components described above) may include identifying the code repository that contains the code. For example, the system may identify, based on the attempt, the code repository that contains the code. As an example, based on an initiation of a build process for the attempt, the system may retrieve metadata for the build process, and the system may identify the code repository from the metadata. For example, the system may extract, from the metadata, repository information indicating the code repository. In some embodiments, the system may extract, from the metadata, entity information indicating an entity (e.g., a user device or a version management system) responsible for triggering the attempt. Based on the entity information, the system may identify that use of the deployment agent by the entity is restricted. For example, the restriction may require validation of the code deployment, as described herein, before deployment of the code is allowed. The metadata presents information about the build process in a structured way, thereby improving the speed and efficiency at which particular information can be located and accessed.

At step 440, process 400 (e.g., using one or more components described above) may include retrieving information that identifies the software application (e.g., an entire software application or a component of the software application). For example, the system, based on the identity of the code repository, may retrieve information that identifies the software application associated with the code repository. As an example, retrieving the information that identifies the software application may include transmitting the repository information that indicates the code repository to a code repository registry service (e.g., via an API), and receiving the information that identifies the software application from the code repository registry service. Communication with the code repository registry service enables identifying the association between the software application and the code repository, which enables the integration of data maintained by different, unrelated systems.

At step 450, process 400 (e.g., using one or more components described above) may include retrieving a list of change requests associated with the software application. For example, the system may retrieve, based on the identity of the software application, a list of change requests associated with the software application. As an example, retrieving the list of change requests may include transmitting information that identifies the software application to a change management system (e.g., via an API), and receiving the list of change requests from the change management system. Communication with the change management system enables the integration of data maintained by different, unrelated systems.

At step 460, process 400 (e.g., using one or more components described above) may include determining whether a change request, from the list of change requests, validates the attempt. For example, to determine whether the change request validates the attempt, the system may first identify whether the change request is associated with an approved status. The system may also identify whether the change request indicates a deployment time window that encompasses a time of the attempt. The system may then determine whether the change request validates the attempt based on identifying whether the change request is associated with the approved status and identifying whether the change request indicates the deployment time window that encompasses the time of the attempt. For example, the change request having the approved status and being timely indicates that there is an approved and timely code deployment for the software application corresponding to the attempt, thereby indicating that the attempt is proper. Conversely, if the change request (e.g., all change requests from the list of change requests) is not associated with an approved status or is not timely, then this indicates that there is no corresponding approved and timely code deployment corresponding to the attempt, thereby indicating that the attempt is not proper.

Thus, if the system determines that the change request validates the attempt, then the system may cause (e.g., allow) the code deployment pipeline to use the deployment agent to deploy the code to the computing environment. For example, the pause on the deployment of the code to the computing environment may be lifted to allow the code deployment pipeline to use the deployment agent to deploy the code to the computing environment. In some embodiments, causing the code deployment pipeline to use the deployment agent to deploy the code to the computing environment may include allowing the build process to continue. In other examples, the build process may be allowed to complete prior to intercepting the attempt. The build process may include compiling the code, packaging the software application, and/or building artifacts for deployment.

At step 470, process 400 (e.g., using one or more components described above) may include terminating the deployment of the code to the computing environment. For example, the system may terminate the deployment of the code to the computing environment by the deployment agent based on a determination that no change request validates the attempt. As an example, the system may terminate the deployment of the code by causing aborting of the code deployment pipeline. In some embodiments, causing aborting of the code deployment pipeline may include transmitting, by a plugin for a pipeline execution system, a message to the pipeline execution system, and the message indicates that the code deployment pipeline is to be aborted. By ensuring that only valid code deployments to the computing environment (e.g., a production environment) are performed, the stability and security of the computing environment are improved. For example, terminating invalid (e.g., unauthorized and/or untimely) code deployments reduces instability, security vulnerabilities, premature introduction of features, inadvertent rolling back of features, or the like, that may otherwise occur. Thus, techniques described herein conserve substantial processing resources that may otherwise be expended toward remediating an invalid deployment (e.g., processing resources used for rolling back to an earlier, stable codebase).

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method of terminating unauthorized code deployments.
2. The method of embodiment 1, comprising: detecting, by a device, an attempt by a code deployment pipeline to use a deployment agent to deploy code to a computing environment, wherein the code is from a code repository that relates to a software application; intercepting, by the device, the attempt prior to deployment of the code to the computing environment by the deployment agent, wherein interception of the attempt pauses deployment of the code to the computing environment; identifying, by the device and based on the attempt, the code repository that contains the code; retrieving, by the device and based on the code repository, information that identifies the software application associated with the code repository; retrieving, by the device and based on the software application, a list of change requests associated with the software application; determining, by the device, whether a change request, from the list of change requests, validates the attempt; and terminating, by the device, the deployment of the code to the computing environment by the deployment agent based on a determination that no change request validates the attempt.
3. The method of any one of the preceding embodiments, wherein determining whether the change request validates the attempt comprises: identifying whether the change request is associated with an approved status; identifying whether the change request indicates a deployment time window that encompasses a time of the attempt; and determining whether the change request validates the attempt based on identifying whether the change request is associated with the approved status and identifying whether the change request indicates the deployment time window that compasses the time of the attempt.
4. The method of any one of the preceding embodiments, wherein detecting the attempt by the code deployment pipeline to use the deployment agent to deploy the code to the computing environment comprises: identifying a label assigned to the deployment agent that is to be used; and identifying that the label indicates that use of the deployment agent is restricted.
5. The method of embodiment 4, wherein intercepting the attempt comprises: intercepting the attempt based on identifying that the label indicates that use of the deployment agent is restricted.
6. The method of any one of the preceding embodiments, wherein detecting the attempt by the code deployment pipeline to use the deployment agent to deploy the code to the computing environment comprises: detecting, using an event listener on an event stream, an event indicating the attempt.
7. The method of embodiment 6, wherein intercepting the attempt comprises: triggering, using the event listener, an execution of one or more operations synchronously with a job of the deployment agent; and executing the one or more operations to delay the job of the deployment agent until completion of the one or more operations.
8. The method of any one of the preceding embodiments, further comprising: retrieving metadata associated with the attempt; extracting, from the metadata, entity information indicating an entity responsible for triggering the attempt; and identifying, based on the entity information, that use of the deployment agent by the entity is restricted.
9. The method of any one of the preceding embodiments, wherein identifying the code repository that contains the code comprises: retrieving metadata associated with the attempt; and extracting, from the metadata, repository information indicating the code repository.
10. The method of any one of the preceding embodiments, wherein retrieving the information that identifies the software application associated with the code repository comprises: transmitting repository information that indicates the code repository to a code repository registry service; and receiving the information that identifies the software application from the code repository registry service.
11. The method of any one of the preceding embodiments, wherein retrieving the list of change requests associated with the software application comprises: transmitting the information that identifies the software application to a change management system; and receiving the list of change requests from the change management system.
12. The method of any one of the preceding embodiments, further comprising: determining that the change request validates the attempt; and causing the code deployment pipeline to use the deployment agent to deploy the code to the computing environment based on a determination that the change request validates the attempt.
13. The method of any one of the preceding embodiments, further comprising: retrieving the code from the code repository; and initiating a build process on the code.
14. The method of any one of the preceding embodiments, wherein terminating the deployment of the code comprises: causing aborting of the code deployment pipeline.
15. The method of any one of the preceding embodiments, wherein causing aborting of the code deployment pipeline comprises: transmitting, by a plugin for a pipeline execution system, a message to the pipeline execution system, wherein the message indicates that the code deployment pipeline is to be aborted.
16. One or more non-transitory, computer-readable mediums storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. A system for terminating unauthorized code deployments, the system comprising:
one or more memories; and
one or more processors, communicatively coupled to the one or more memories, configured to:
detect, using an event listener, an attempt by a code deployment pipeline to use a deployment agent to deploy code to a computing environment,
wherein the code is from a code repository that relates to a software application;
intercept the attempt prior to deployment of the code to the computing environment by the deployment agent,
wherein interception of the attempt pauses deployment of the code to the computing environment;
identify, based on metadata associated with the attempt, the code repository that contains the code;
transmit, using a first application programming interface (API) endpoint for a code repository registry service, a first API request requesting information that identifies the software application associated with the code repository;
receive, at the first API endpoint, a first API response containing the information that identifies the software application;
transmit, using a second API endpoint for a change management system, a second API request requesting a list of change requests associated with the software application;
receive, at the second API endpoint, the list of change requests associated with the software application;
determine whether a change request, from the list of change requests, validates the attempt,
wherein the change request validates the attempt if the change request is associated with an approved status and indicates a deployment time window that encompasses a time of the attempt; and
terminate the deployment of the code to the computing environment by the deployment agent based on a determination that no change request validates the attempt.

2. A method of terminating unauthorized code deployments, comprising:
detecting, by a device, an attempt by a code deployment pipeline to use a deployment agent to deploy code to a computing environment,
wherein the code is from a code repository that relates to a software application;
intercepting, by the device, the attempt prior to deployment of the code to the computing environment by the deployment agent,
wherein interception of the attempt pauses deployment of the code to the computing environment;
identifying, by the device and based on the attempt, the code repository that contains the code;
retrieving, by the device and based on the code repository, information that identifies the software application associated with the code repository;
retrieving, by the device and based on the software application, a list of change requests associated with the software application;
determining, by the device, whether a change request, from the list of change requests, validates the attempt; and
terminating, by the device, the deployment of the code to the computing environment by the deployment agent based on a determination that no change request validates the attempt.

3. The method of claim 2, wherein determining whether the change request validates the attempt comprises:
identifying whether the change request is associated with an approved status;
identifying whether the change request indicates a deployment time window that encompasses a time of the attempt; and
determining whether the change request validates the attempt based on identifying whether the change request is associated with the approved status and identifying whether the change request indicates the deployment time window that compasses the time of the attempt.

4. The method of claim 2, wherein detecting the attempt by the code deployment pipeline to use the deployment agent to deploy the code to the computing environment comprises:
identifying a label assigned to the deployment agent that is to be used; and
identifying that the label indicates that use of the deployment agent is restricted.

5. The method of claim 4, wherein intercepting the attempt comprises:
intercepting the attempt based on identifying that the label indicates that use of the deployment agent is restricted.

6. The method of claim 2, wherein detecting the attempt by the code deployment pipeline to use the deployment agent to deploy the code to the computing environment comprises:
detecting, using an event listener on an event stream, an event indicating the attempt.

7. The method of claim 6, wherein intercepting the attempt comprises:
triggering, using the event listener, an execution of one or more operations synchronously with a job of the deployment agent; and
executing the one or more operations to delay the job of the deployment agent until completion of the one or more operations.

8. The method of claim 2, further comprising:
retrieving metadata associated with the attempt;
extracting, from the metadata, entity information indicating an entity responsible for triggering the attempt; and
identifying, based on the entity information, that use of the deployment agent by the entity is restricted.

9. The method of claim 2, wherein identifying the code repository that contains the code comprises:
retrieving metadata associated with the attempt; and
extracting, from the metadata, repository information indicating the code repository.

10. The method of claim 2, wherein retrieving the information that identifies the software application associated with the code repository comprises:
transmitting repository information that indicates the code repository to a code repository registry service; and
receiving the information that identifies the software application from the code repository registry service.

11. The method of claim 2, wherein retrieving the list of change requests associated with the software application comprises:
transmitting the information that identifies the software application to a change management system; and
receiving the list of change requests from the change management system.

12. The method of claim 2, further comprising:
determining that the change request validates the attempt; and
causing the code deployment pipeline to use the deployment agent to deploy the code to the computing environment based on a determination that the change request validates the attempt.

13. The method of claim 2, further comprising:
retrieving the code from the code repository; and
initiating a build process on the code.

14. The method of claim 2, wherein terminating the deployment of the code comprises:
causing aborting of the code deployment pipeline.

15. The method of claim 14, wherein causing aborting of the code deployment pipeline comprises:
transmitting, by a plugin for a pipeline execution system, a message to the pipeline execution system, wherein the message indicates that the code deployment pipeline is to be aborted.

16. A non-transitory, computer-readable medium, comprising instructions that, when executed by one or more processors, cause operations comprising:
detecting an attempt by a code deployment pipeline to use a deployment agent to deploy code to a computing environment,
wherein the code is from a code repository that relates to a software application;
retrieving a list of change requests associated with the software application;
determining whether a change request, from the list of change requests, validates the attempt; and
selectively terminating or causing deployment of the code to the computing environment by the deployment agent based on whether the change request validates the attempt.

17. The non-transitory, computer-readable medium of claim 16, wherein determining whether the change request validates the attempt comprises:
identifying whether the change request is associated with an approved status;
identifying whether the change request indicates a deployment time window that encompasses a time of the attempt; and
determining whether the change request validates the attempt based on identifying whether the change request is associated with the approved status and identifying whether the change request indicates the deployment time window that compasses the time of the attempt.

18. The non-transitory, computer-readable medium of claim 16, wherein the instructions further cause operations comprising:
transmitting repository information that indicates the code repository to a code repository registry service; and
receiving information that identifies the software application from the code repository registry service.

19. The non-transitory, computer-readable medium of claim 16, wherein retrieving the list of change requests associated with the software application comprises:
transmitting information that identifies the software application to a change management system; and
receiving the list of change requests from the change management system.

20. The non-transitory, computer-readable medium of claim 16, wherein the instructions further cause operations comprising:
determining that the change request validates the attempt, and
wherein selectively terminating or causing deployment of the code to the computing environment comprises:
causing the code deployment pipeline to use the deployment agent to deploy the code to the computing environment based on a determination that the change request validates the attempt.
